(19) United States
(12) Patent Application Publication
(10) Pub. No.: US 2009/0138357 A1
(43) Pub. Date: May 28, 2009

(54) METHOD AND APPARATUS FOR SYSTEM COMMUNICATIONS APPLICATION BETWEEN DIGITAL MAGAZINES, CATALOGS, AND/OR BOOKS AND DIGITAL ADVERTISING BROKERS

(76) Inventor: Robert Christian Riggs, Tulsa, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/324,433

(22) Filed: Nov. 26, 2008

Related U.S. Application Data
(60) Provisional application No. 60/990,402, filed on Nov. 27, 2007.

(51) Int. Cl. G06Q 30/00

(52) U.S. Cl. 705/14; 705/26

(57) ABSTRACT

In accordance with an embodiment of the present invention, a Software Communications Application associated with a digital magazine, catalog, book, or other digital media item will request a digital ad from a Digital Advertising Broker. The Digital Advertising Broker will analyze the metadata contained within the data request and send a digital ad to the Software Communications Application along with additional metadata. The Software Communications Application will place the digital advertisement into the digital media item and store the metadata associated with the transaction. The metadata will then be used for future metric and reporting associated with the transaction.

### RELATED CASES

This application claims the benefit of U.S. Provisional Patent Application Ser. No. 60/990,402 filed on Nov. 27, 2007, and incorporates said provisional application by reference into this document as if fully set out at this point.

### FIELD OF THE INVENTION

The present invention relates generally to the field of digital delivery of multimedia content and, more specifically, to systems and methods for the delivery of targeted digital ads as digital representations of physical content media (e.g. magazines, books or catalogs).

### BACKGROUND OF THE INVENTION

It has long been a goal of publishers of print-based content, such as magazines, catalogs, books, and the like, to provide their on-line readers with an interactive experience that mirrors that of the printed counterpart. Readers are obviously very familiar and comfortable with actions required to page through physical media. However, replicating that experience in an interactive product has proven to be problematic for publishers.

First, most modern computers utilize a mouse (or, in the case of laptops a track pad) as a pointing device and such devices are well suited to the use of directional icons such as “arrows” to signal a forward or backward page turn. However, the straightforward replacement presentation of a new page by writing over the graphic image of the old page with that of the new does not replicate the print experience, i.e., does not provide a user with the experience of a page turn.

Additionally, there has been and continues to be a concern on the part of electronic publishers regarding the security of the digital works that they distribute. As is well known, digital content that is distributed in an unprotected format is subject to unauthorized copying and distribution of the content, with a subsequent loss in potential sales. Thus, digital rights management has become increasingly key to the distribution of digital media, as unprotected distribution can quickly result in loss of control of the content.

On the other hand, a number of factors argue for increased distribution of digital content in spite of the problems involved, the foremost of which being the financial incentives for being able to do so. For example, distribution of a printed work in digital form could potentially increase the number of readers (at the possible risk, of course, of cannibalizing the print sales). Further, reducing a printed document to electronic form makes it possible to deliver information to a user when and where he or she wants it: there is no need for the user to make a trip to a book store or magazine stand.

Additionally, the on-line publication of a paper document could potentially provide the publisher with a significant revenue opportunity at a relatively low marginal increase in production costs. For example, advertisers will often pay to place banner or other ads on the periphery of a digital work. If the user has Internet connectivity, clicking on such a banner would typically activate the user's browser (if not already activated) and take the user to the advertised web site.

Obviously, additional revenue could also be obtained by charging a print advertiser in order to have the in-print ads distributed in digital form in the electronic version of the publication. However, the traditional advertiser's approach to ad placement (e.g., an advertiser who pays to run an ad in a publication that is likely to be read by potential customers) is certainly subject to challenge in digital media. More particularly, given the interactive nature of the medium and the fact that there may be some particularized information available about a reader it may not make sense to run the same ad for every reader of a given publication as has been done in the case of print media.

Thus, what is needed is a system and method that allows publishers to deliver printed media in an electronic form to end-users and to control the ads and other multimedia materials that are viewed therein.

Heretofore, as is well known in the publishing industry, there has been a need for an invention to address and solve the above-described problems. Accordingly, it should now be recognized, as was recognized by the present inventors, that there exists, and has existed for some time, a very real need for a system and method that would address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of the invention within the ambit of the appended claims.

### SUMMARY OF THE INVENTION

According to a first preferred aspect of the instant invention, there is provided herein a system and method for use of a Software Communications Application between a Digital Content Display (e.g., software for displaying a digital representation of physical media, such as a magazine, catalog, and/or book), and a Digital Advertising Broker, whereby the Digital Advertising Broker receives digital advertising requests, analyzes, and fulfills the advertising request, and returns a digital advertisement for placement inside the Digital Content Display.

A Digital Content Display can potentially provide publishers with a significant revenue opportunity by allowing a Software Communications Application to communicate between the Digital Advertising Broker and a Digital Content Display, whereby the Digital Advertising Broker analyzes the request, checks its ad network for the availability of a digital advertisement, supplies the digital advertisement to the Software Communications Application for subsequent placement of the advertisement inside the Digital Content Display.

In accordance with the first embodiment of the present invention, a Software Communications Application contained within a Digital Content Display will request a digital advertisement from a Digital Advertising Broker. The Digital Advertising Broker will fulfill the request by analyzing the metadata contained within the data request from the Software Communications Application. The Digital Advertising Broker will preferably submit a digital advertisement to the Software Communications Application along with additional metadata if needed. The Software Communications Application will place the digital advertisement into the Digital Content Display and temporarily store the metadata associated with the transaction between the Software Communications Application and the Digital Advertising Broker. The metadata is then preferably permanently stored inside a database for future metric (e.g., statistical analysis) and reporting associated with the transaction.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention.

### BRIEF DESCRIPTION OF THE DRAWINGS

Other objects and advantages of the invention will become apparent upon reading the following detailed description and upon reference to the drawings in which:

FIG. 1 contains a schematic illustration of some preferred aspects of the instant invention.

FIG. 2 contains a preferred operating logic suitable for use with the instant invention.

FIG. 3 illustrates the general environment of the instant invention.

### DETAILED DESCRIPTION OF THE PREFERRED EMBODIMENTS

While this invention is susceptible of being embodied in many different forms, there is shown in the drawings, and will herein be described, some specific embodiments of the instant invention. It should be understood, however, that the present disclosure is to be considered an exemplification of the principles of the invention and is not intended to limit the invention to the specific embodiments or algorithms so described.

The following general definitions are used throughout:
1. System Communication Application—Software that is associated with a digital magazine, catalog, book, or other electronic information item and that provides a communications request to a Digital Advertising Broker for a digital advertisement and receives a communications response from the Digital Advertising Broker.
2. Digital Content Display—A digital representation of a physical or printed media such as a magazine, catalog, or book. Software that presents a digital form of the physical or printed magazine, catalog, or book.
3. Digital Advertising Broker—Software that preferably provides digital communication and advertising services and that facilitates the receipt of digital advertising request, transmission of digital advertising to the requester, and metrics and reporting of the transmission.
4. Metadata—In brief, metadata is data about data. In the preferred embodiment, an item of metadata may describe an individual datum, or content item, or a collection of data including multiple content items.

In accordance with the first embodiment of the present invention, a remote user will access a Digital Content Display through an Internet browser or a similar application (e.g., a customized program for use in communicating with a remote provider of digital content). The Digital Content Display will then preferably be downloaded (in whole or in part, e.g., one page or pair of pages at a time) to the user's computer for viewing.

The Digital Content Display will preferably be opened within the user's browser (e.g., Explorer, Netscape, Firefox, Safari, etc.) but a customized viewer or reader application could also be used. Upon the user request of a specific page of the Digital Content Display, in the preferred arrangement metadata is utilized to determine when and where the advertisement is displayed from the Advertising Broker to the Software Communications Application into said page. Metadata will preferably include information about when, where, and how the advertisement is placed.

The advertisement file and metadata that is preferably provided by the Advertising Broker to the Software Communications Application may be any electronic file format.

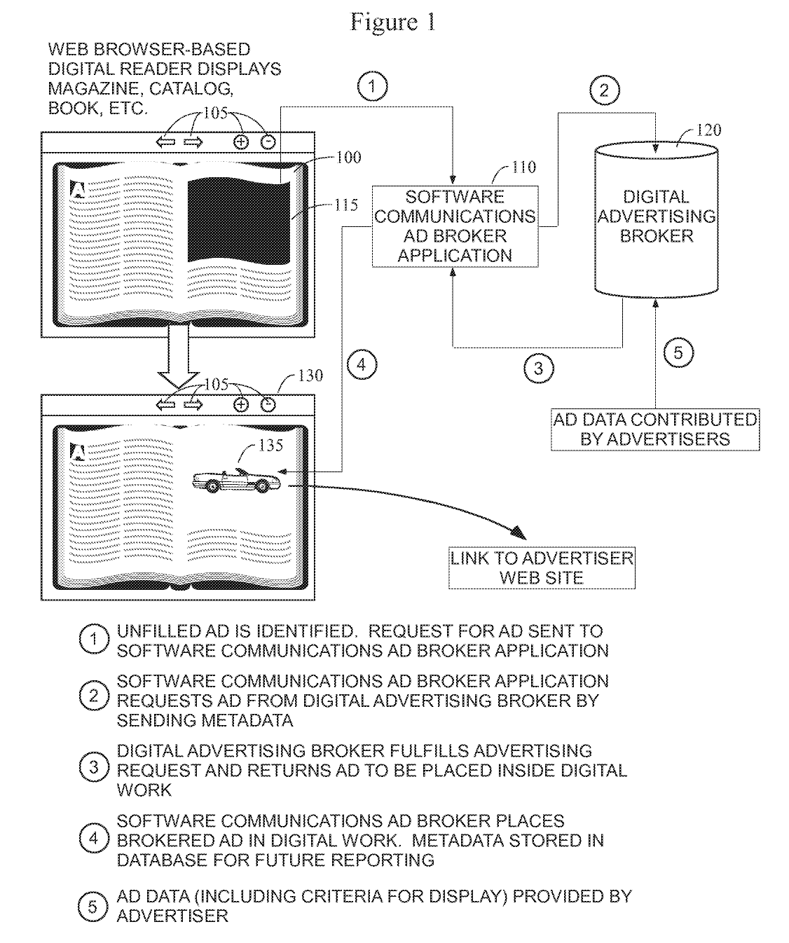

The metadata associated with the return response from the Digital Advertising Broker to the Software Communications Application and the placement of the digital advertisement into the Digital Content Display as shown in FIG. 1, is further referred to hereforth as an Advertising Impression Event, i.e., an instance where an ad is presented to a user. The metadata associated with this Advertising Impression Event will preferably be placed inside a database for permanent storage where it will be available for future metrics and reporting.

In the preferred embodiment, the invention will consist of a
1.) A Digital Content Display;
2.) A Software Communications Application;
3.) A Communications Process to request and receive a digital advertisement from a Digital Advertising Broker;
4.) A Communication Process to facilitate the placement of a digital advertisement inside a Digital Content Display and the storage of associated metadata returned from the Digital Advertising Broker; and
5.) The metrics and reporting system associated with the transactions between the Software Communications Application and the Digital Advertising Broker and Advertising Impression Event within the Digital Content Display.

In a preferred embodiment, the Software Communications Application will monitor and facilitate requests from the Digital Content Display and will retrieve requested files from multiple sources including potentially multiple Digital Advertising Brokers. The Software Communications Application will preferably analyze metadata from the request of the Digital Content Display, and if the metadata contains a request for a file from a Digital Advertising Broker, the Software Communications Application will provide a metadata information set to the Digital Advertising Broker that preferably contains:
1.) An ad request ID;
2.) The ad specifications;
3.) Metadata and key words to enable the Digital Advertising Broker to select the appropriate advertising file for the request; and
4.) Ad type blocker identifier IDs, in the event that the user or programmer wishes to block specific types of advertisements from appearing.

The Software Communications Application will preferably also handle the return response from the Digital Advertising Broker, which will typically include the advertising file, and metadata associated with the advertising file. The Software Communications Application will facilitate the placement of the advertisement file into the Digital Content Display, and store and send the metadata associated with the transactions to a permanent database.

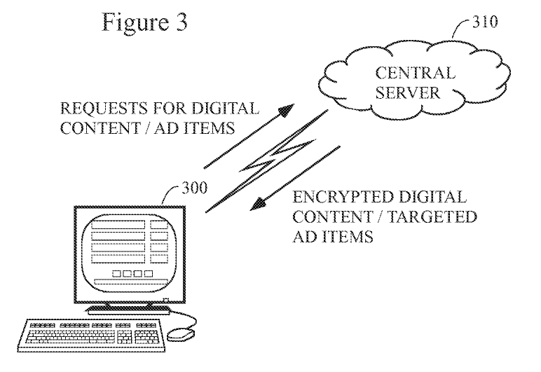

Turning now to FIG. 3, wherein the general environment of the instant invention is illustrated, according to a preferred embodiment a user's personal computer 300 will be in electronic communication (e.g., via the Internet) with a central server 310. The user's computer will be utilized for purposes of displaying the digital content delivered by the instant invention and the ad data as is described hereinafter. In a preferred arrangement, the user's computer will contain a browser or other computer program suitable for displaying the digital media items that have been requested by the user.

The central server 310 will respond to the request for digital content and, preferably, encrypt the digital content and transmit it to the user's computer 300 where it can be unencrypted and displayed. Additionally, it is contemplated that within the requested digital media items will be one or more unfilled regions into which ads may be inserted. As is explained in greater detail hereinafter, each unfilled ad region will preferably be identified by the user's computer 300 and a request sent back to the central server 310 for an ad item to fill that region. Of course, those of ordinary skill in the art recognize that, in some circumstances, the ads might be delivered along with the requested media items.

In a preferred arrangement, the central server 310 will then respond to the request by selecting and transmitting one or more ad items which will preferably be targeted to the particular user who is viewing the media item. That is, based on the user's previous browsing history, ad click-through history, stated preferences (e.g., preferences that have been explicitly specified by a user), etc., ads will preferably be delivered that have an increased probability of capturing the user's interest. Preferably, the user's computer 300 will integrate the ad items that have been returned from the central server 310 into the digital media item that is being viewed (if they are designed to be placed within the body of the media item) and display them on the user's monitor. Additionally, it is preferred that the user will be able to click through or otherwise select any given ad item to obtain more information about the subject matter of the ad. In some preferred embodiments each ad will contain a link to the advertiser's web site or another ad-related site.

Turning next to FIG. 1, wherein the instant invention is displayed in greater detail, in a preferred arrangement, a user's computer will display a representation 100 of a book, magazine, or other media item on the user's screen. As might be expected, the graphic representation of the media item will be accompanied by icons or other indicia 105 that would allow the user to page forward or backward through the chosen document, magnify or shrink the displayed image, close the current media item, call up a menu of the other media items that might be available, etc. In the preferred embodiment, the representation 100 will be chosen to resemble its physical counterpart.

As is generally indicated in FIG. 1, in a preferred arrangement, a media item will be transmitted to the user's computer at the request of the user. Within each media item will be one or more ad regions (represented by the black graphical region 115 in this figure) which are placeholders into which ads will be placed for display to the user. Each of these unfilled ad regions 115 will preferably be sensed by the operating software and a corresponding request for an ad to fill that space will preferably be sent to the software communications ad broker 120 application.

The communications ad broker 120 will preferably be responsible for forwarding this request on to the digital advertising broker. In a preferred arrangement, the software communications ad broker 120 will compile elements of metadata that will be subsequently transmitted to the digital advertising broker 120 for purposes of requesting an ad. It should be noted and remembered that metadata that is compiled might contain preferences or tendencies of the viewing user which could be used to help select an advertisement. For example, a user that has expressed an explicit preference (e.g., by way of a program preferences option) to receive certain kinds of ads will, where possible, see that request satisfied by the digital ad broker. Where the user has not expressed an explicit preference, the instant invention will preferably examine the user's click-throughs or other indications of interest in a subject matter as a general guide for the sort of ad that should be displayed.

However the user's preferences (if any) are established, the instant invention will preferably communicate to the digital ad broker 120 information such as the general dimensions of the ad region (e.g., one column wide, half page, full page, etc.), its location within the document and/or page, and any data relevant to the user's likes and/or dislikes, the general subject matter of the viewed document, etc. That being said, it should be clear to those of ordinary skill in the art that the sorts of information listed previously that might be communicated via metadata are only suggestions and many other items of information might be sent in addition to these or instead.

The metadata items will preferably be transmitted to the digital ad broker 120 where they will be decoded to reconstruct the information provided by the software communications ad broker 120. Where it makes sense to do so, the digital advertising broker 120 will seek an ad from within its database that is of the sort that would be most likely to be attractive to the user. In some embodiments, though, the digital ad broker will return a specific ad immaterial of the desires of the user. This might occur in an instance where an advertiser has paid to have a particular ad appear in every instance, whether or not there is any evidence that the reader might be predisposed to view its subject matter favorably. In other cases, an advertiser might elect to only pay each time the ad is actually transmitted and presented to a user, in which case it would be reasonable to only show the ad to users who might have an interest. Those of ordinary skill in the art will recognize when each would be appropriate.

Ad data that is accessible by the digital advertising broker 120 will typically have been previously stored within a database that is computer readable and accessible thereby. In some preferred embodiments, ad data will be contributed by advertisers and stored in the database where it can be recalled and transmitted to the user's computer. Additionally, in some preferred variations the advertiser will provide information about the target audience for the ad (e.g., male or female, teen, adult, or the elderly, etc.), thereby making it possible to limit delivery of that at to a particular target audience. Associated with each ad will preferably be an Internet or other link that allows a user to directly click on an ad region and be transferred, preferably via a browser, to the advertiser's website where additional information concerning can be obtained.

Receipt of a request for an ad including its associated metadata (which preferably communicates the user's preferences or tendencies and/or other information) will be resolved by the digital advertising broker 120 through the selection and transmission of an ad from within its database back to the software communications ad broker 110. As has been indicated previously, the ad might be specifically selected based on the tendencies of the user and/or simply selected based on the desires of the advertiser.

Preferably, the ad will be transmitted back to the software communications ad broker application 110 which, in turn, will direct the placement of that ad in the region provided. In the example of FIG. 1, the graphic image of an automobile 135 within the media item 130 represents the ad that was selected from the database and transmitted back to the user's computer for display within the digital media item 130 under review by the user.

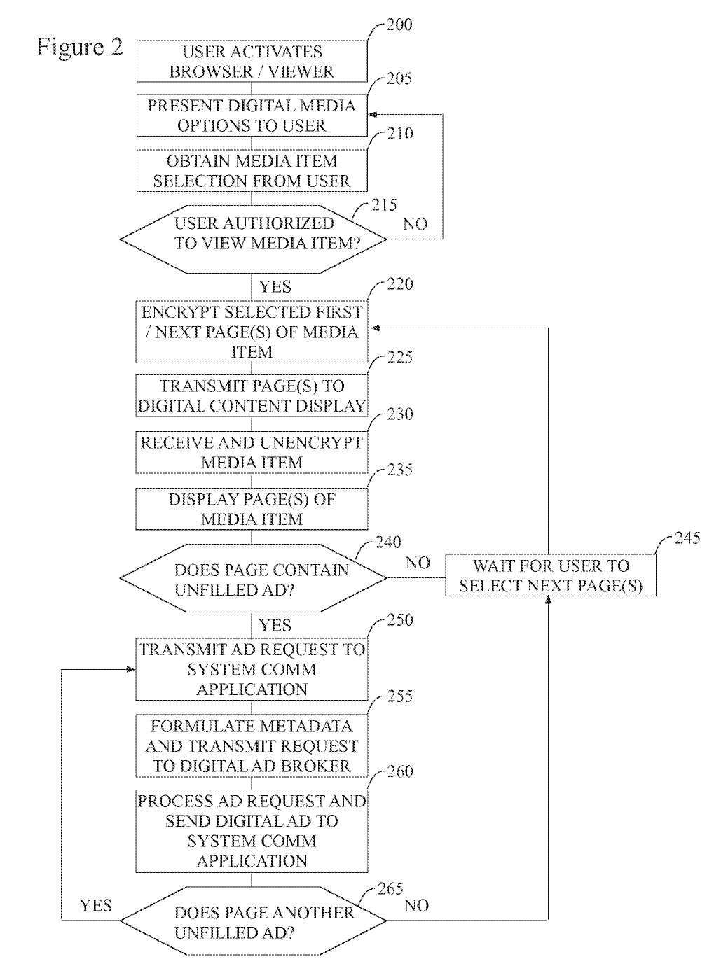

Turning next to FIG. 2, wherein a detailed operating logic suitable for use with the instant invention is illustrated, according to a first preferred step, a user will activate a browser or other viewer (step 200). The browser/viewer will preferably executed on the user's personal computer, although it certainly could be executed remotely with the screen images being transmitted back to user's terminal (e.g., the user could use a terminal server or similar arrangement to activate a browser and execute it on a remote computer).

As a next preferred step 205, the user will be presented with one or more digital media items that are potentially available for viewing. In some preferred embodiments, the listing of digital media items will include one or more books, one or more magazines, one or more other print and/or multimedia items, etc. In a preferred arrangement, these items will be presented in menu form to the user for him or her to select. In some embodiments, each media item will be represented by a graphic icon.

As a next preferred step 210, the instant invention will preferably obtain a selection of a media item from the listing provided. As might be traditionally done, this selection could take the form a user clicking on an icon representative of the digital media item.

As a next preferred step 215, a determination will preferably be made as to whether or not the user is authorized to view the selected media item. Of course, in some cases, the user would only be presented items that he or she is authorized to view. However, in other instances, a user would be allowed to select a media item and, for example, preview that item before paying. In still other scenarios, a user will select a media item and be asked to provide a password or other indication that authorization has been obtained to view this item. Those of ordinary skill in the art will recognize that many variations of this theme might be used depending on the needs of the user and the needs of the publisher of the media item.

In the event that the user is authorized to view the selected media item (“YES” branch of decision item 215), the instant invention will preferably transmit that information to a central server for fulfillment of the request. The central server will then preferably encrypt at least the first page or pages of the media item and transmit that data back to the user's computer (steps 220 and 225). As has been suggested previously, encryption is likely to be an important component of the instant invention as control of the digital rights of the media items will likely be necessary to prevent piracy. Note that in the preferred arrangement, one or two (e.g., facing pages) of the first pages of the document will be initially transmitted back to the user. Then, as the user requests either proceeding or following pages from the media item, that request will be transmitted back to the central server for fulfillment and the next pages will then transmitted back for viewing by the user. Note, of course, that in some preferred arrangements the entire document will be encrypted and transmitted to the user at the outset where it can be unencrypted and displayed locally as needed.

As the next preferred step 230, the instant invention will receive and unencrypt the media item or portion thereof that has been transmitted from the central server. Methods of transmitting, encrypting, and unencrypting media items are well known to those of ordinary skill in the art.

As the next preferred step, the instant invention will display at the user's computer the page or pages that have been requested by that user (step 235). As is generally indicated in FIG. 1, the instant invention will preferably display a graphical representation of a book, magazine, etc., to give the use the general impression that he or she is viewing the corresponding printed media item. Additionally, in a preferred arrangement, the instant invention will respond to page turn requests (either forward or backward) by providing graphical representation of a page being physically turned, with the page underneath gradually emerging into view as would be the case with a physically turned page.

As a next preferred step, the instant invention will determine whether or not the page contains unfilled ad regions (decision item 240). If the selected page does not contain unfilled ad regions (the “NO” branch), the instant invention will preferably then allow the user to view the displayed pages and wait for the user to request a next or previous page (step 245). Upon a receipt of such a request for additional media pages, the instant invention will preferably transmit that request back to the central server where it will be filled and returned for display to the user unless, of course, the document has previously been downloaded in its entirety.

On the other hand, if the requested page contains one or more unfilled ad regions, the instant invention will preferably transmit an ad request to the system communications application (step 250). As has been discussed previously, the instant invention will preferably obtain the ad by sending metadata back to a central server, the metadata preferably containing information such as user preferences, dimensions of the ad region available, and other information that might be useful in the selection of an ad item (step 255).

As a next preferred step, the ad request will be processed at the central server and a digital ad will be returned to the software communications ad broker application for display on the user's terminal (step 260). As has been discussed previously, the user's tendencies and/or preferences (if they are available) will be used as part of the ad selection process unless the instant invention has been instructed to display a particular ad no matter what the desires of the user might be.

In some instances, multiple ads might appear on a page. In such a case, the instant invention would preferably branch back to step 250 so that additional ads can be requested from the central server (the “YES” branch of decision item 265). Once all of the ad regions have been filled (i.e., the “NO” branch of decision item 265), the instant invention will preferably allow the user to examine the currently displayed media item page (or pages) until a signal is obtained from a user that additional pages are required (step 245).

It should be noted and remembered that, although the phrase “central server” has been used herein, that term has been used only for purposes of illustration and the instant inventor is well aware that a “central server” might consist of multiple servers located around the world which cooperate in some sense. Thus, the term “central server” should be interpreted as broadly as possible to include multiple servers or a single server, depending on the wishes of the system designer.

In a preferred arrangement, the instant invention will preferably track statistical information related to each ad that is presented to a user including, for example, how many times an ad has been presented to users, the click-through rate for that ad, etc. In some preferred embodiments, each user's individual click-through history will be compiled and used to select ads that are subsequently displayed. For example, users that have shown in interest in electronic gadgetry by either clicking through these sorts of ads previously or by requesting media items that deal with this subject matter, will preferably be more likely to receive ads of that sort in the future.

In another preferred arrangement, the instant invention will provide search features for use within each article, book, etc., requested by a user. The search features might include the ability to locate specific text within the media item and/or search for ad content within the entire publication. Additionally, in some instances, the user will be provided with an opportunity to forward ads and/or the media item itself to another user.

In some instances, the instant invention will be configured to allow the user to control or customize the menu of media items that is presented to him or her. For example, in some cases, the user might specify a preference for a particular type of news (e.g., business, sports, world news, etc.) and the user would then be presented with a menu limited to such media items.

In other instances, the instant invention will be configured to deliver audio and/or video data to the user. In such a case, the unfilled ad regions will preferably take the form of banner ads that can be clicked by the user during the playing of the audio or video work. In some preferred embodiments, the ad will change depending on the current context of the movie or audio work. For example, during a car chase, the banner ad might change to provide a clickable link to obtain information about automobiles or tires. During a love scene, the banner ad might be changed to provide a link to flowers, chocolates, or other romantically-associated gift items.

With respect to the term “computer”, this term should be broadly construed to include desktops and laptops as well as handheld devices (e.g., Windows Mobile™ and Palm™ devices) including smart phones, etc.

Finally, the term “database” as used herein should be broadly interpreted to include traditional databases (hierarchical, relational, etc.) as well as sequential files, keyed files, etc. In brief, the term database could potentially be applied to any organized collection of information that is accessible and readable by a computer.

Thus, the present invention is well adapted to carry out the objectives and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those skilled in the art, without departing from the spirit of the inventive concept the scope of which is to be determined by the following claims.

What is claimed is:

1. A method of delivering digital content to a user of a computer, comprising the steps of:
a. obtaining a plurality of digital ad items;
b. storing said plurality of digital ad items within a database;
c. obtaining from a user a selection of one of said plurality of digital media items;
d. transmitting to the user at least a portion of said selected digital media item;
e. determining whether said transmitted portion of said selected digital media item has at least one ad region therein;
f. displaying at least a portion of said at least a portion of said selected digital media item to the user; and,
g. if said displayed portion of said selected digital media item has at least one ad region therein, for each of said at least one ad region therein
(g1) selecting one of said at least one ad region,
(g2) transmitting an ad request to a central server,
(g3) within said central server, using said ad request to select one of said at least one digital ad items from within said database,
(g4) transmitting a representation of said selected ad to said computer;
(g5) displaying said representation of said selected ad within said selected ad region, and,
(g6) performing steps (g1) through (g5) until at least one of said at least one ad region has a representation of an ad therein.

2. The method of delivering digital content to a user of a computer according to claim 1, wherein step (g2) comprises the steps of:
(i) determining at least one item of information associated with said selected ad region,
(ii) encoding at least said at least one item of information associated with said selected ad region as at least one item of metadata, and,
(i) transmitting an ad request to a central server, said ad request at least including said at least one item of metadata.

3. The method of delivering digital content to a user of a computer according to claim 2, wherein said at least one item of information associated with said selected ad region is selected from a group consisting of a user preference, an ad location, an ad type, a digital media type, and, an ad type blocker.

4. The method of delivering digital content to a user of a computer according to claim 1, wherein step (g6) comprises the steps of:
(g6) performing steps (g1) through (g6) until at least one of said at least one ad regions has a representation of an ad therein, and,
(g7) storing data representative of said ad request in computer readable form.

5. The method of delivering digital content to a user of a computer according to claim 1, comprising the further step of:
(h) storing in computer readable form information representative of each of said transmitted ad request until at least a plurality of information representative of each of said transmitted ad requests are stored;
(i) reading at least a portion of said plurality of stored information representative of each of said transmitted ad requests;
(j) performing an analysis of any of said read stored information representative of each of said transmitted ad requests; and,
(k) displaying a report representative of said analysis.

6. The method of delivering digital content to a user of a computer according to claim 1, wherein said digital media item is selected from a group consisting of a digital book, a digital magazine, and a digital catalog.

7. The method of delivering digital content to a user of a computer according to claim 1, wherein said selected digital media item has a printed version and wherein step (f) comprises the step of:
(f1) displaying at least a portion of said at least a portion of said selected digital media item to the user, wherein said displayed at least a portion of said at least a portion of said selected digital media item has an appearance representative of said printed version.

8. The method of delivering digital content to a user of a computer according to claim 1, wherein step (a) comprises the step of:
(a1) obtaining from at least one advertiser a plurality of digital ad items.
